(19) United States
(12) Patent Application Publication
(10) Pub. No.: US 2003/0188466 A1
(43) Pub. Date: Oct. 9, 2003

(54) Self-adhesive greeting card

(76) Inventor: Tsai-Chi Chang, Taipei (TW)

Correspondence Address: Tsai-Chi Chang, PO Box 82-144, Taipei, TW

(21) Appl. No.: 10/114,039

(22) Filed: Apr. 3, 2002

(51) Int. Cl. G09F 1/00

(52) U.S. Cl. 40/124.11; 40/594

(57) ABSTRACT

A self-adhesive greeting card includes a card body folded into two sections, one of the sections being formed with a semi-circular perforated line and a pressed line joining two ends of the semi-circular perforated line to form a semi-circular tab, and a double-sided adhesive fastener having one side attached to one side of the semi-circular tab and another side provided with a cover, whereby the greeting card can be readily attached to anywhere as desired.

### BACKGROUND OF THE INVENTION

1. Field of the Invention

This invention is related to a greeting card and in particular to one which can be attached to anywhere as desired.

2. Description of the Prior Art

It has been found that the conventional greeting card includes a thin, rectangular card body member folded into two sections. However, when desired to attach such a greeting card to a wall, window, or the like, it is necessary to use a piece of adhesive tape in order to fix the greeting card thereon, hence causing much inconvenience in use. Furthermore, the two sections of the greeting card always tend to move away from each other thereby making it difficult to put into an envelope (see FIG. 7).

Therefore, it is an object of the present invention to provide an improved greeting card which can obviate and mitigate the above-mentioned drawbacks.

### SUMMARY OF THE INVENTION

This invention relates to an improved greeting card.

It is the primary object of the present invention to provide a self-adhesive greeting card which can be readily attached to anywhere as desired.

It is another object of the present invention to provide a greeting card which can easily put into an envelope.

It is still another object of the present invention to provide a greeting card which is simple in construction.

It is still another object of the present invention to provide a greeting card which is facile to manufacture.

It is a further object of the present invention to provide a greeting card which is low in cost.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numberals refer to identical or similar parts.

### BRIEF DESCRIPTION OF THE DRAWINGS

The invention is further described hereafter, by way of example only, with reference to the accompanying drawings, in which:

FIG. 1 is a perspective view of a first preferred embodiment according to the present invention;

FIG. 2 is a perspective view of a second preferred embodiment according to the present invention;

FIG. 3 is a perspective view of a third preferred embodiment according to the present invention;

FIG. 4 is a sectional view illustrating how the third preferred embodiment works;

FIG. 5 is a working view of the present invention;

FIG. 6 illustrates how a greeting card according to the present invention is smoothly put into an envelope; and

FIG. 7 illustrates why it is difficult to put a prior art greeting into an envelope.

### DETAILED DESCRIPTION OF THE PREFERRD EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, such alterations and further modifications in the illustrated device, and such further applications of the principles of the invention as illustrated herein being contemplated as would normally occur to one skilled in the art to which the invention relates.

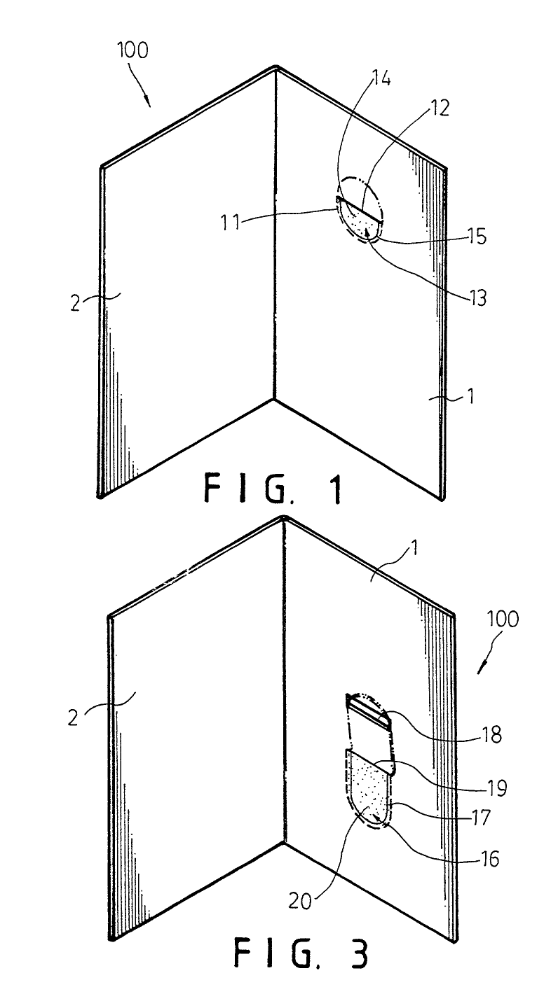

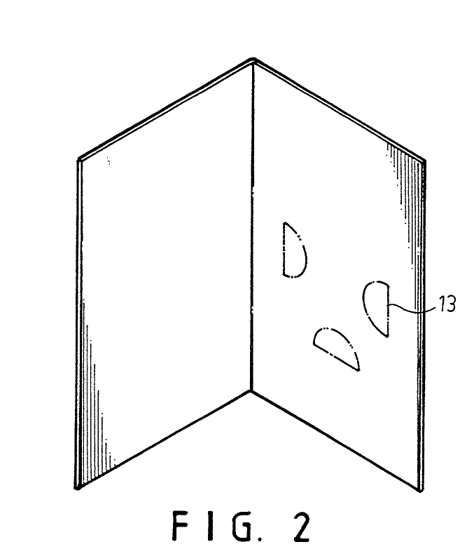

With reference to the drawings and in particular to FIGS. 1 and 2 thereof, the self-adhesive greeting card 100 according to the present invention comprises a rectangular card body folded into two sections 1 and 2. The card body may be circular, triangular, trapezoid, or the like in shape. The section 1 is formed with a semi-circular perforated line 11 and a horizontal folding line 12 joining two ends of the semi-circular perforated line 11 to form a semi-circular tab 13 at the upper middle portion of the card body. A double-sided adhesive fastener 14 is attached to the semi-circular tab 13 and has a cover 15 thereon.

When desired to attach the greeting card to a window 200 (see FIG. 5), it is only necessary to push open the semi-circular tab 13 and fold the semi-circular tab 13 upwardly along the folding line 12. Then, the cover 15 is peeled off from the double-sided adhesive fastener 14 thereby enabling the greeting card to be readily attached to the window 200.

As shown in FIG. 2, the tab 13 may be provided on any other position of the card body as desired.

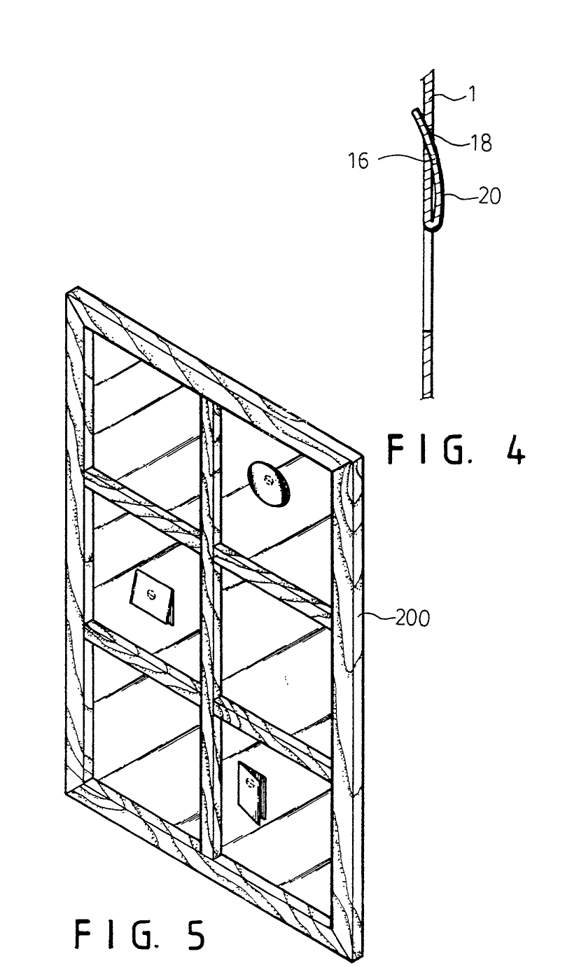

FIGS. 3 and 4 illustrate another preferred embodiment of the present invention. As illustrated, the section 1 of the self-adhesive greeting card 100 has a horizontal slot 18, a curved perforated line 17 below the horizontal slot 18, and a horizontal folding line 19 joining two ends of the curved perforated line 17 to form a tab 16 at the middle portion of the card body. A double-sided adhesive fastener 20 is attached to the tab 16 and has a cover thereon. The upper end of the tab 16, when pushed open, will be able to pass through the horizontal slot 18 from the rear side. When desired to attach the greeting card to a wall or the like, simply push open the tab 16 and fold the tab 16 upwardly along the folding line 17 to make the upper end of the tab 16 go through the horizontal slot 18 from the rear side. Thereafter, peel off the cover from the double-sided adhesive fastener 20 and stick the tab 16 on the wall.

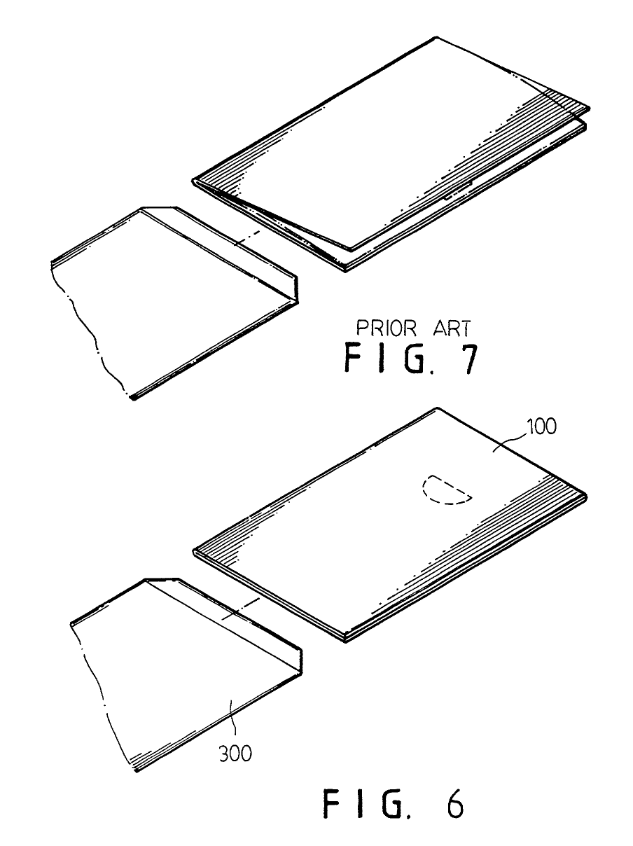

Further, when desired to put the greeting card into an envelope, it is only necessary to remove the cover from the double-sided adhesive fastener 20 and close the greeting card so that the two sections 1 and 2 of the card body will be kept together thereby facilitating the insertion of the greeting card 100 into the envelope 300 (see FIG. 6).

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

I claim:

1. A self-adhesive greeting card comprising:
a card body folded into two sections, one of said sections being formed with a semi-circular perforated line and a horizontal folding line joining two ends of said semi-circular perforated line to form a semi-circular tab; and
a double-sided adhesive fastener having one side attached to one side of said semi-circular tab and another side provided with a cover;
whereby said tab can be easily pushed open to attach said greeting card to anywhere as desired.

2. The self-adhesive greeting card as claimed in claim 1, further comprising a slot above said semicircular tab which is capable of passing through said slot when peeled off along said semi-circular perforated line.
